(19) United States
(12) Patent Application Publication
(10) Pub. No.: US 2013/0239679 A1
(43) Pub. Date: Sep. 19, 2013

(54) THREE-AXIS GYROSCOPE

(71) Applicant: Pavel Kornilovich, Corvallis, OR (US)

(72) Inventor: Pavel Kornilovich, Corvallis, OR (US)

(21) Appl. No.: 13/418,999

(22) Filed: Mar. 13, 2012

(51) Int. Cl. G01C 19/56

(52) U.S. Cl. 73/504.12

(57) ABSTRACT

Apparatus related to measuring angular velocities in three-space are provided. Drive masses distributed in a plane are force-oscillated in two orthogonal directions such that gyration of the collective is performed. Sense masses coupled by flexures to the drive masses are each displaceable along a respective single degree of freedom in response to angular velocities about a vector orthogonal to that degree of freedom. Electronic circuitry measures the respective sense mass displacements and provides corresponding signaling. The drive masses and sense masses can be formed such that a microelectromechanical system (MEMS) device is defined.

### BACKGROUND

Sensors and devices for detecting and measuring position, angular orientation, displacement, velocity and acceleration are sought after in numerous areas of endeavor. Navigation, consumer electronics, geology, and oil exploration are just a few such areas. Reduced size and production cost of such devices are also desirable. The present teachings address the foregoing and related concerns.

### BRIEF DESCRIPTION OF THE DRAWINGS

The present embodiments will now be described, by way of example, reference to the accompanying drawings, in which:

FIG. 1 depicts a plan view of a single-axis gyroscopic sensor according to one example of the present teachings;

FIG. 1A depicts a plan view flexure detail of the sensor of FIG. 1;

FIG. 1B depicts a plan view of an alternative flexure detail for a sensor;

FIG. 2 depicts a plan view of a single-axis gyroscopic sensor according to another example;

FIG. 3 depicts a plan view single-axis gyroscopic sensor according to still another example;

FIG. 4 depicts a plan schematic view of a three-axis gyroscope in accordance with the present teachings;

FIG. 5 depicts a table of behavioral characteristics of the gyroscope of FIG. 4;

FIG. 6 depicts a plan schematic view of a three-axis gyroscope and accelerometer device in accordance with the present teachings.

### DETAILED DESCRIPTION

### Introduction

Apparatus and methods related to measuring angular velocities in three-space are provided, Plural drive masses are distributed in a plane and are force-oscillated in two orthogonal directions such that gyration of the collective is performed. Sense masses are coupled by flexures to the drive masses and are each displaceable along a respective single degree of freedom. Such displacements occur in response to angular velocities about a vector orthogonal to the particular degree of freedom of a given sense mass. Electronic circuitry measures the respective sense mass displacements and provides corresponding signaling. The drive masses and sense masses can be formed such that a microelectromechanical system (MEMS) device is defined.

In one example, an apparatus includes a plurality of drive masses disposed in a plane. The drive masses are configured to be simultaneously oscillated in two orthogonal directions in the plane. The apparatus also includes a plurality of sense masses, Each sense mass is configured to be displaced within a respective single-axis range in response to angular velocity of the apparatus about a vector orthogonal to the respective single-axis range. Each drive mass supports one or more of the sense masses.

In another example, a microelectromechanical system (MEMS) device includes a substrate and a plurality of drive masses supported in overlying relationship to the substrate. The drive masses are distributed in a plane. The drive masses are configured to be gyrated as an entity by way of forced oscillations in two orthogonal axes in the plane. The MEMS device also includes a plurality of pairs of sense masses. Each pair is supported by a respective one of the drive masses. Each sense mass is displaceable in a single degree of freedom in response to angular velocity of the MEMS device about a vector orthogonal to the respective degree of freedom of that sense mass.

### First Illustrative Sensor

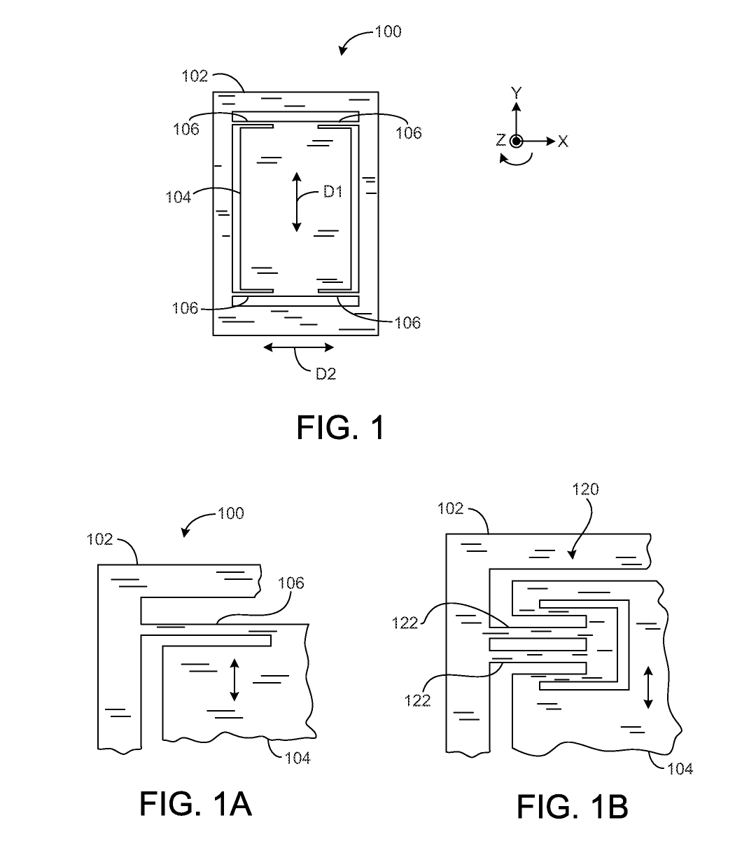

Attention is now turned to FIG. 1, which depicts a plan view of single-axis gyroscopic sensor (sensor) 100. The sensor 100 is illustrative and non-limiting in accordance with the present teachings. Thus, other sensors and gyroscopic devices incorporating such other sensors are also contemplated. The sensor 100 is depicted in a three-axis frame of reference defined by mutually orthogonal vectors “X”, “Y” and “Z”.

The sensor 100 includes a drive mass 102. The drive mass 102 is formed from a solid material. The drive mass is suspended within the sensor frame by a plurality of flexures (not shown) allowing it to displace along the “X” axis. The sensor 100 also includes a sense mass 104 suspended within the drive mass 102 by way of a plurality of flexures 106 extending there between. The respective flexures 106 are configured such that the sense mass 104 can be displaced within a “Y” axis as indicated by the double-arrow D1. Thus, the sense mass 104 is supported within and surrounded by the drive mass 102, and is defined by a single degree of freedom along the “Y” axis.

In one example, the drive mass 102, the sense mass 104 and the respective flexures 106 are formed from a silicon wafer by way of photolithography such that the sensor 100 is defined by a monolithic structure. Other suitable materials or formative processes can also be used. In one example, the sensor 100 is defined by an overall length (“Y”) of 2.0 millimeters, a width (“X”) of 1.5 millimeters, and a relatively uniform thickness (“Z”) of 0.2 millimeters. Other suitable respective dimensions can also be used.

Typical normal operation of the sensor 100 is as follows: the drive mass 102 is oscillated (or vibrated) along the “X” axis as indicated by the double-arrow D2 by way of a drive device or apparatus discussed in further detail below. The sense mass 104 is coupled to the drive mass 102 so as to oscillate in a corresponding manner. That is, forced oscillation or stimulus of the drive mass 102 in the “X” axis does not result in significant displacement of the sense mass 104 in the “Y” axis, provided that the sensor 100 is angularly stationary. In one example, the sensor 100 is oscillated in the “X” axis at about 6,000 Hertz with a peak-to-peak amplitude of about 10 micrometers. Other suitable frequencies or amplitudes can also be used.

However, rotation of the sensor 100 about the “Z” axis, during forced oscillation in the “X” axis, results in a corresponding displacement of the sense mass 104 along the “Y” axis. This displacement is attributable to the Coriolis effect. The magnitude of the sense mass 104 displacement along “Y” corresponds to the angular velocity about “Z”, while the sign or direction of displacement corresponds to the direction of rotation about the “Z” axis. Measurement of the magnitude and/or direction of displacement of the sense mass 104 can thus be correlated to the angular velocity and rotational sense about “Z”. The sensor 100 is thus also referred to herein as a “Z” axis sensor 100.

Reference is now made to FIG. 1A, which depicts a plan view of a detail of the sensor 100. A flexure 106 extends from a corner portion of the sense mass 104 coupling it with the drive mass 102. Each flexure 106 is thus defined by a single supporting extension.

Reference is made now to FIG. 1B, which depicts a plan view of a flexure 120, in accordance with the present teachings. The flexure 120 is an alternative form to that of the flexure 106. The flexure 120 includes two respective extensions 122 ultimately coupling the sense mass 104 to the drive mass 102. The flexure 120 is generally more complex in form than the flexure 106, but offers relatively greater and more linear displacement along the “Y” axis, and greater structural strength and resistance to displacement of the sense mass 104 all directions except along the “Y” axis. Other suitable flexure forms can also be used.

### Second Illustrative Sensor

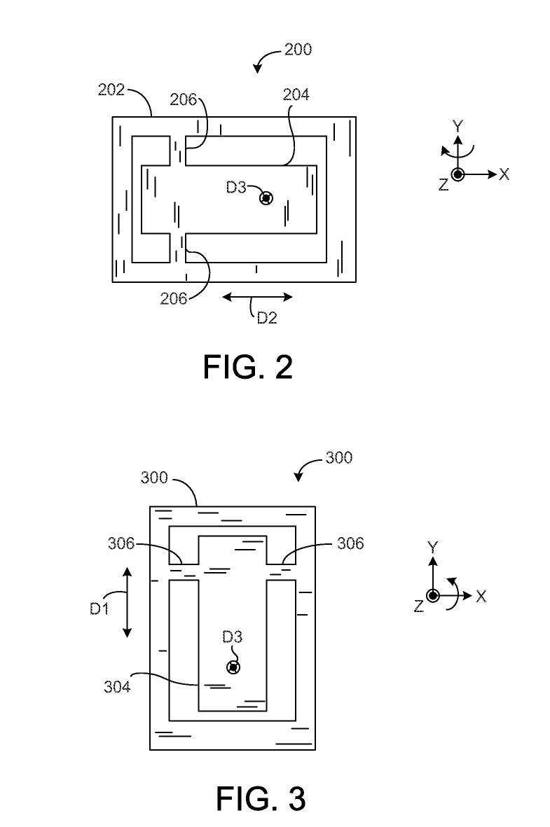

Attention is now turned to FIG. 2, which depicts a plan view of single-axis gyroscopic sensor (sensor) 200. The sensor 200 is illustrative and non-limiting in accordance with the present teachings. Thus, other sensors and gyroscopic devices incorporating such various sensors are also contemplated. The sensor 200 is depicted in a mutually orthogonal, three-axis frame of reference. In one example, the sensor 200 is defined by length, width and thickness dimensions equivalent to those described above for the sensor 100. Other suitable dimensions can also be used.

The sensor 200 includes a drive mass 202 formed from a solid material, The drive mass is suspended within the device frame by a plurality of flexures (not shown) allowing it to displace along the “X” axis. The sensor 200 also includes a sense mass 204 suspended within the drive mass 202 by way of a plurality of flexures 206 extending there between. The respective flexures 206 are configured such that the sense mass 204 can be displaced in a cantilever-like manner along the “Z” axis as indicated by the directional indicator D3. The sense mass 204 is therefore supported within and surrounded by the drive mass 202, and is defined by a single degree of freedom along the “Z” axis.

In one example, the drive mass 202, the sense mass 204 and the respective flexures 206 are formed from a silicon wafer by way of photolithography such that the sensor 200 is defined by a monolithic structure. Other suitable materials or formative processes can also be used.

Typical normal operation of the sensor 200 is as follows: the drive mass 202 is oscillated (or vibrated) along the “X” axis as indicated by the double-arrow D2. The sense mass 204 is coupled to the drive mass 202 so as to oscillate in a corresponding manner, such that forced oscillation of the drive mass 202 in the “X” axis does not result in significant displacement of the sense mass 204 in the “Z” axis under non-rotational conditions.

Rotation of the sensor 200 about the “Y” axis during oscillation in the “X” axis results in a corresponding cantilever displacement of the sense mass 204 along the “Z” axis. The magnitude of the sense mass 204 displacement along “Z” corresponds to the angular velocity about “Y”, while the sign or direction of displacement corresponds to the rotational sense about the “Z” axis. The sensor 200 is thus also referred to herein as a “Y” axis sensor 200.

### Third Illustrative Sensor

Attention is now turned to FIG. 3, which depicts a plan view of single-axis gyroscopic sensor (sensor) 300. The sensor 300 is illustrative and non-limiting in accordance with the present teachings. Thus, other sensors and gyroscopic devices incorporating such various sensors are also contemplated. The sensor 300 is depicted in a mutually orthogonal, three-axis frame of reference. In one example, the sensor 300 is essentially equivalent to the sensor 200, rotated ninety degrees in the X-Y plane. In one example, the sensor 300 is defined by length, width and thickness dimensions equivalent to those described above for the sensor 100. Other suitable dimensions can also be used.

The sensor 300 includes a drive mass 302 suspended within the device frame by a plurality of flexures, and a sense mass 304 suspended there within by way of a plurality of flexures 306, all formed from a solid material. The respective flexures 306 are configured such that the sense mass 304 is displaceable along a “Z” axis as indicated by the directional indicator D3. The sense mass 304 is therefore defined by a single degree of freedom along the “Z” axis.

In one example, the drive mass 302, the sense mass 304 and the respective flexures 306 are formed from a silicon wafer by way of photolithography such that the sensor 300 is defined by a monolithic structure. Other suitable materials or formative processes can also be used.

Typical normal operation of the sensor 300 is as follows: the drive mass 302 is oscillated (or vibrated) along the “Y” axis as indicated by the double-arrow D1, as discussed in further detail below. The sense mass 304 is coupled to the drive mass 302 so as to oscillate in a corresponding manner, such that forced oscillation of the drive mass 302 in the “Y” axis does not result in significant displacement of the sense mass 304 in the “Z” axis under non-rotational conditions.

Rotation of the sensor 300 about the “X” axis during oscillation in the “Y” axis results in a corresponding cantilever displacement of the sense mass 304 along the “Z” axis. The magnitude of the sense mass 304 displacement along “Z” corresponds to the angular velocity about “X” while the sign or direction of displacement corresponds to the direction of rotation about the “Z” axis. The sensor 300 is thus also referred to herein as an “X” axis sensor 300.

### Illustrative Gyroscope

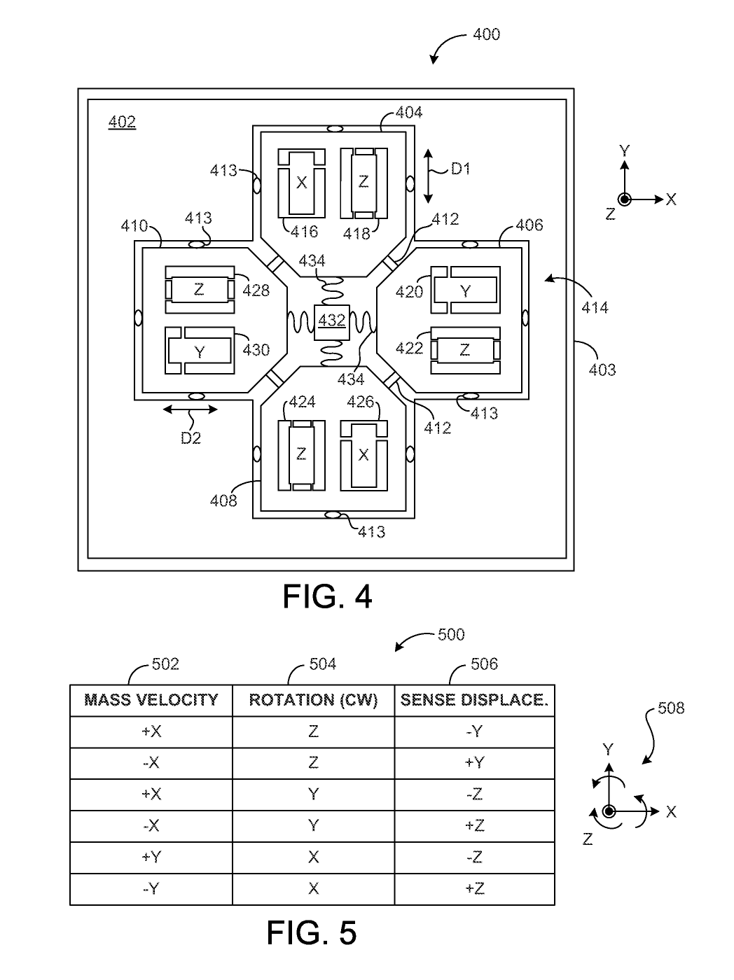

Reference is now made to FIG. 4, which depicts a plan schematic view of a three-axis gyroscope (gyroscope) 400 in accordance with the present teachings. The gyroscope 400 is illustrative and non-limiting with respect to the present teachings. Other suitable gyroscopes can be defined and used in accordance there with. The gyroscope 400 is depicted in a mutually orthogonal, three-axis frame of reference. In one example, the gyroscope 400 is formed so as to define at least a portion of a microelectromechanical systems (MEMS) device. Other configurations or structures according to the present teachings can also be defined and used.

The gyroscope 400 includes a frame 402. In one example, the frame 402 is defined by a silicon wafer or portion thereof. Other suitable materials can also be used, The frame 402 supports various elements of the gyroscope 400 as described below. The frame 402 is bonded or otherwise joined to an underlying wafer (or substrate) 403. The frame 402 and the substrate 403 are fixed to one another such that no relative motion occurs between them during normal operations.

The gyroscope 400 also includes drive masses 404, 406, 408 and 410, respectively. The drive masses 404-410 are coupled or connected to one another by way of respective distance-fixing (or offset maintaining) extensions 412, and are connected to (i.e., suspended within) the frame 402 by way of respective flexures (or elastic elements) 413. In one example, the drive masses 404-410, the extensions 412 and the flexures 413 are formed from a silicon wafer by way of photolithography such that a monolithic entity 414 is defined. Other suitable constructs can also be used. The

[symbol]

The drive mass 404 is formed to define an “X” axis sensor 416 analogous to the sensor 300 described above, and a “Z” axis sensor 418 analogous to the sensor 100 described above. Thus, the drive mass 404 serves as a common drive mass for the two respective sensors 416 and 418.

In turn, the drive mass 406 is formed to define a “Y” axis sensor 420 analogous to the sensor 200 described above, and a “Z” axis sensor 422. The drive mass 408 is formed to define a “Z” axis sensor 422, and an “X” axis sensor 424. Furthermore, the drive mass 410 is formed to define a “Z” axis sensor 428, and a “Y” axis sensor 430. Thus, the drive masses 404-410 collectively define two “X” axis sensors, two “Y” axis sensors and four “Z” axis sensors.

The substrate 403 includes or defines a central post or standard 432 that extends away from a planar aspect of the substrate 403. The drive masses 404-410 are mechanically coupled to the standard 432 by way of respective elastic or “spring” elements 434. In another example, the standard 432 and the elastic elements 434 are omitted. The drive masses 404-410 are coupled to, or are otherwise affected by, one or more electrostatic drivers. Non-limiting examples of such electrostatic drivers (or actuators) are described in U.S. Pat. No. 5,986,381 to Hoen et al., issued Nov. 16, 1999, and which is herein incorporated by reference in its entirety. Other suitable drivers can also be used.

Specifically, the drive masses 404 and 408 are coupled to be force oscillated along the “Y”0 axis as depicted by the double-arrow D1, The drive masses 406 and 410 are coupled to be force oscillated along the “X” axis as depicted by the double-arrow D2. In one example, the respective oscillations in the X-Y plane are sinusoidal in waveform and offset by ninety degrees of phase angle from each other, resulting in full gyrations (i.e., three-hundred sixty degrees) of the coupled drive masses 404-410. The immediate foregoing behavior is also attributable to the distance (or spacing) fixing characteristic of the extensions 412, which can be characterized by a slight bending or flexing. Other suitable forced oscillations or stimulus techniques can also be used.

The forced oscillations of the drive masses 404-410 in the X-Y plane cause the sensors 416-430 to exhibit respective displacements in accordance with respective rotations (i.e., angular velocities) of the gyroscope 400 about the three mutually-orthogonal axis due to Coriolis forces. For example, rotation of the gyroscope 400 about the “Z” axis results in corresponding displacements of the “Z” axis sensors 418, 422, 424 and 428. In another example, rotation about the “Y” axis results in corresponding displacements of the “Y” axis sensors 420 and 430. Analogous behavior is exhibited by the “X” axis sensors 416 and 426.

Simultaneous angular velocities about two or three of the mutually-orthogonal axis results in simultaneous displacements of the corresponding sensors 416-430. Capacitance-based sensors, for example, can be used to provide electrical signals corresponding to such respective displacements of the sensors 416-430 during normal operations. Non-limiting examples of such capacitance-based sensors are described in U.S. Pat. No. 7,484,411 to Walmsley, issued Feb. 3, 2009, and which is herein incorporated by reference in its entirety. Other suitable displacement sensing and measuring techniques can also be used.

### Illustrative Behavioral Characteristics

Attention is turned now to FIG. 5, which depicts a table 500 of behavioral characteristics in accordance with the present teachings. The table 500 corresponding to normal operating behaviors of the gyroscope 400 described above. Other suitable devices defined by other behaviors in accordance with the present teachings can also be used.

The table 500 includes a column of mass velocities 502 corresponding to the forced motions of the drive masses 404-410. The table 500 also includes a column of rotations 504 corresponding to angular velocity of the gyroscope 400 about respective axis. The table further includes a column 506 of sense mass displacements corresponding to the response behaviors of the respective sensors 416-430.

For example, when the drive masses 404-410 are being forced in the positive “X” direction and the gyroscope 400 is being rotated in a clockwise sense about the “Z” axis, the sense masses of the “Z” axis sensors 418, 422, 424 and 428 will exhibit respective displacements along the negative “Y” axis. In another example, when the drive masses 404-410 are being forced in the negative “X” direction and the gyroscope 400 is being rotated in a clockwise sense about the “Y” axis, the sense masses of the “Y” axis sensors 420 and 430 will exhibit respective displacements along the positive “Z” axis, and so on.

Angular senses for clockwise rotations as depicted in the table 500 are as indicated by the orthogonal vectors icon 508. In turn, the directional responses of the sense masses (i.e., positive or negative) would be the opposite of those indicated for counter-clockwise rotations of the gyroscope 400.

### Illustrative Gyroscope and Accelerometer

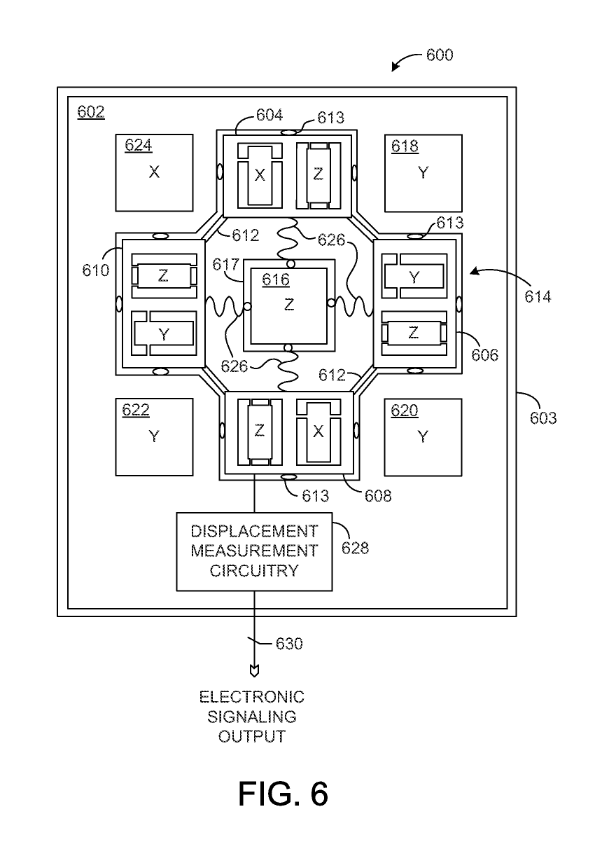

Reference is now made to FIG. 6, which depicts a plan schematic view of a three-axis gyroscope and accelerometer (sensing device) 600 in accordance with the present teachings. The sensing device 600 is illustrative and non-limiting with respect to the present teachings. Other suitable sensing devices can be defined and used in accordance there with. The sensing device 600 is depicted in a mutually orthogonal, three-axis frame of reference. In one example, the sensing device 600 is formed so as to define at least a portion of a microelectromechanical systems (MEMS) device. Other configurations or structures according to the present teachings can also be defined and used.

The sensing device 600 includes a frame 602 defined, for non-limiting example, by a silicon wafer or other suitable material. The frame 602 overlies a supporting wafer (or substrate) 603. The sensing device 600 also includes drive masses 604-610, respectively, each defining (or including) respective “X”, “Y” or “Z” axis sensors analogous to those described above (e.g., sensors 416-430).

The drive masses 604-610 are coupled to each other by way of substantially rigid extensions 612, and are suspended within the frame 602 by way of flexures or elastic elements 613 so as to be force oscillated in two orthogonal directions in the X-Y plane. Thus, the sensing device 600 includes a monolithic entity 614 that is analogous in structure and operation to the monolithic entity 414 of the gyroscope 400.

The sensing device 600 also includes respective accelerometers 616, 618, 620, 622 and 624 bonded or anchored to the frame 602. In particular, the accelerometer 616 provides electrical signaling corresponding to accelerations along the “Z” axis. In turn, the accelerometers 618 and 622 provide electrical signaling corresponding to accelerations along the “Y” axis. Furthermore, the accelerometers 620 and 624 provide electrical signaling corresponding to accelerations along the “X” axis. The drive masses 604-610 can be coupled to a structure 617 that is fixed to or extending from the underlying wafer 603 by way of respective elastic or “spring” elements 626. In another example, the structure 617 and the elastic elements 626 are not present.

The sensing device 600 also includes displacement measuring electronic circuitry (circuitry) 628. The circuitry 628 can include or be defined by a microprocessor, a state machine, an application-specific integrated circuit (ASIC), and so on. The circuitry 628 is configured to receive signals from the respective sense masses and to provide an electronic signaling output 630 to communicate angular velocities in three-space as detected by the sensing device 600. Such signals can be received from the sense masses by way of capacitive or other suitable detection schemes.

The sensing device 600 is configured to provide electrical signaling corresponding to accelerations and angular velocities in three-space. One having ordinary skill in the motion and position sensing or related arts can appreciate that such signals can be digitally quantified, filtered or otherwise processed for use in determining acceleration or velocity, displacement, angular rotation or orientation with respect to a frame of reference, and so on. Non-limiting examples of applications contemplated by the present teachings include cellular or “smart” phones, portable computing devices, geological sensing apparatus, inertial navigation systems, platform or antenna stabilization apparatus, and so on.

In general and without limitation, the present teachings contemplate vibratory gyroscopes and sensing devices that include gyroscopes formed and packaged as MEMS devices. Such a gyroscope includes a plurality of drive masses distributed in a plane, each drive mass supporting or formed to define a pair of respective sense masses (i.e., sensors). Each sense mass is coupled by flexure suspension to the corresponding drive mass so as to be defined by a single degree of freedom or displaceable axis. Accelerometers can also be included with a gyroscope within a single MEMS form-factor.

Stimulus devices, such as electrostatic drives, are used to forcibly oscillate the drive masses in two orthogonal directions within the plane such that a full gyrating motion is controllably sustained. Rotation of the gyroscope about any one or more of the mutually-orthogonal axis in three-space results in displacement of those respective sense masses configured to react to the corresponding Coriolis forces.

Capacitive sensing or other detection determines the respective displacements of the sense masses and electronic signaling corresponding to the displacements is provided. Such signals can be quantified or processed accordingly such that angular velocities, angular accelerations, relative changes in orientation and so on can be determined. Movement, position, rotation, displacement and other characteristics can be determined (e.g., by known mathematical operations such as time integration), recorded and used in any number of apparatus or system in accordance with the present teachings.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. An apparatus, comprising:
a plurality of drive masses disposed in a plane, the drive masses configured to be simultaneously oscillated in two orthogonal directions in the plane; and
a plurality of sense masses, each sense mass configured to be displaced within a respective single-axis range in response to angular velocity of the apparatus about a vector orthogonal to the respective single-axis range, each drive mass supporting one or more of the sense masses.

2. The apparatus according to claim 1 further comprising electronic circuitry configured to detect displacements of the respective sense masses.

3. The apparatus according to claim 2, the electronic circuitry further configured to provide electronic signaling corresponding to angular velocities of the apparatus about three mutually-orthogonal axes.

4. The apparatus according to claim 1, the sense masses and the drive masses being respective aspects of a microelectromechanical system (MEMS) device.

5. The apparatus according to claim 1, the drive masses supported within a frame, the frame fixedly joined to the substrate, the frame and the drive masses and the sense masses formed from a single silicon wafer by way of photolithography.

6. The apparatus according to claim 1 further comprising a plurality of accelerometers respectively disposed proximate to the drive masses.

7. The apparatus according to claim 1, the drive masses being mechanically coupled to each other by way of respective extensions.

8. The apparatus according to claim 1, the drive masses and the sense masses formed from a monolithic material.

9. The apparatus according to claim 1, each sense mass being supported by either flexure coupling or torsional coupling to the corresponding drive mass.

10. The apparatus according to claim 1, the drive masses configured such that the simultaneous oscillation in the two orthogonal directions results in three-hundred sixty degree gyration within the plane.

11. A microelectromechanical system (MEMS) device, comprising:
a substrate;
a plurality of drive masses supported in overlying relationship to the substrate and distributed in a plane, the drive masses configured to be gyrated as an entity by way of forced oscillations in two orthogonal axes in the plane; and
a plurality of pairs of sense masses, each pair supported by a respective one of the drive masses, each sense mass displaceable in a single degree of freedom in response to angular velocity of the MEMS device about a vector orthogonal to the respective degree of freedom.

12. The MEMS device according to claim 11, each pair including:
a sense mass configured to be displaceable in a single degree of freedom within the plane; and
a sense mass configured to be displaceable in a single degree of freedom orthogonal to the plane.

13. The MEMS device according to claim 11, the sense masses collectively defining three mutually-orthogonal degrees of freedom so as respond to angular velocities of the MEMS device about three mutually-orthogonal vectors.

14. The MEMS device according to claim 11 further comprising electronic circuitry configured to sense respective displacements of the sense masses, the electronic circuitry further configured to provide electronic signaling in accordance with the sensing.

15. The MEMS device according to claim 11 further comprising a plurality of accelerometers respectively supported on the substrate.

16. The MEMS device according to claim 11 further comprising a frame fixed to the substrate, the drive masses suspended within the frame, the frame and the drive masses and the sense masses formed from a monolithic material.
